(19) United States
(12) Patent Application Publication
(10) Pub. No.: US 2014/0353002 A1
(43) Pub. Date: Dec. 4, 2014

(54) ELECTRICALLY CONDUCTIVE WIRE AND METHOD OF ITS PRODUCTION

(71) Applicant: NEXANS, Paris (FR)

(72) Inventors: Wolfgang Placke, Bramsche (DE); Henning Tepe, Ankum (DE)

(21) Appl. No.: 14/286,229

(22) Filed: May 23, 2014

(30) Foreign Application Priority Data
May 28, 2013 (EP) 13 305 693.7

(51) Int. Cl. H01B 13/00; H01B 1/02; B21C 1/20

(52) U.S. Cl. CPC H01B 13/0026; B21C 1/20; H01B 13/0016; H01B 13/0006; H01B 1/026
USPC 174/126.2; 72/370.25; 427/117; 427/120

(57) ABSTRACT

An electrically conductive wire (D) is provided which is constructed on the basis of copper and which includes a core (1) as well as a layer (2) metallically connected to the layer (2), while the layer (2) has a proportion of the wire cross section which is between 20% and 50% of the cross section of the wire. The core (1) on the one nano and the layer (2) surrounding the core (1) consist of different materials on the basis of copper.

### RELATED APPLICATION

This application claims the benefit of priority from European Patent. Application No. 13 305 693.7, filed on May 28, 2013, the entirety of which is incorporated by reference.

### BACKGROUND

1. Field of the Invention

The invention relates to an electrically conductive wire and to a method for its manufacture.

2. Description of Related Art

Such a wire is used, for example, for electrical conductors in various forms. Copper conductors containing such a wire have been known for a long time for a large variety of applications. They are used, for example, in electrical connecting lines, in news cables, and in high current and high voltage cables. Depending on the field of application, copper conductors may have various cross sections. They can be constructed as solid conductors or also as high voltage cables in which a larger number of copper wires are roped together. The material used for the copper conductors may, in dependence on the field of application, also have different properties, wherein, on the one hand for example a good electrical conductivity and, on the other hand for example, a high mechanical strength are to be achieved. Electrically well conducting copper conductors can for example be combined with aluminum, and copper conductors with high mechanical strength are for example, connected to steel elements. In all cases, the copper conductor is constructed in accordance with the respective requirements of the purpose of use.

DE 20 2011 108 573 U1 describes a wire for conducting an electrical current with a core wire consisting of a copper alloy which also has fixed dimensions as a layer surrounding the core wire with a better soldering capability than the core wire. The diameter of the core wire and the wall thickness of the layer are predetermined. After the application of the layer on the core wire, the wire may have a desired final diameter. However, it can also be reduced to a predetermined diameter, in the manner of a wire having a core wire and an applied layer in a wire drawing process.

### OBJECTS AND SUMMARY

The invention is based on the object of providing an electrically conductive wire containing copper, and a method for manufacturing thereof, which can be adapted in a simple manner to different properties.

In order to meet this object, a wire is provided which has a core and a layer circumferentially surrounding the wire, in which the core has a proportion of the cross section of the wire which is between 20% and 50%, while the layer has a corresponding proportion of the wire cross section of between 80% and 50% of the wire cross section, wherein the core on one hand and the layer surrounding the core on the other hand, consist of different materials on the basis of copper.

In a first preferred embodiment of the wire, either the core may consist of a non-alloyed copper and the layer surrounding the core may consist of a copper alloy, or vice-versa. The reference to “non-alloyed copper” as the material for the wire surrounding the core, in accordance with the invention, is always a copper material for the wire as it is defined in THE STANDARDS DIN EN 1977: 2013-04 (tables 1 and 2).

In accordance with a second preferred embodiment of the wire, either the core of a first copper alloy and the layer of a first copper alloy surrounding the core may consist of a second copper alloy with an alloying material which differs from the alloying material of the first copper alloy, or vice-versa.

Accordingly, the wire according to the invention consists either of a non-alloyed copper and a copper alloy, or of two different copper alloys. Consequently, for this purpose the wire is constructed in both cases of two different copper materials, wherein the wire can be constructed with different properties by varying the proportions of the different copper materials. Therefore, only the two different materials which are based on copper are used for this purpose, which solely through the exchangeable variable proportions of the total cross section of the wire and the exchangeable arrangement in the core, or in the layer surrounding the core, facilitate the different properties of the wire. In this connection, different properties of the wire are the electrical conductivity, on the one hand, and the mechanical properties on the other hand. A greater proportion of copper an improved electrical conductivity, while an increased proportion of the copper alloy influences the mechanical properties of the wire.

In a preferred embodiment for manufacturing the wire, initially a core is prefabricated which consists either of: non-alloyed copper or of a copper alloy. The core is subsequently pulled through a material which is in the molten state to provide for an outer layer, in which a layer of the material is circumferentially applied in the bath. This is also true analogously when two different copper alloys are used for the core and the layer surrounding the core.

The wire consisting of the core and the layer surrounding the core can, after leaving the bath, be fed to a roll unit for reducing its diameter.

The diameter of the wire can advantageously be reduced in an additional drawing device substantially to a dimension which is suitable for manufacturing an electrical strand conductor consisting of a plurality of wires.

By annealing in a targeted manner additionally, for example, a layer of the wire surrounding the core can be soft annealed, while the core remains hard. However, it is also possible to soft anneal the core, while the material of the outer layers remain hard.

### BRIEF DESCRIPTION OF THE DRAWINGS

Embodiments of the inventive subject matter, including a method for manufacturing the same, are illustrated in the drawings.

In the drawing:

FIG. 1 is a sectional view of a wire according to the invention;

FIG. 2 schematically shows an arrangement for manufacturing a wire according to FIG. 1.

### DETAILED DESCRIPTION

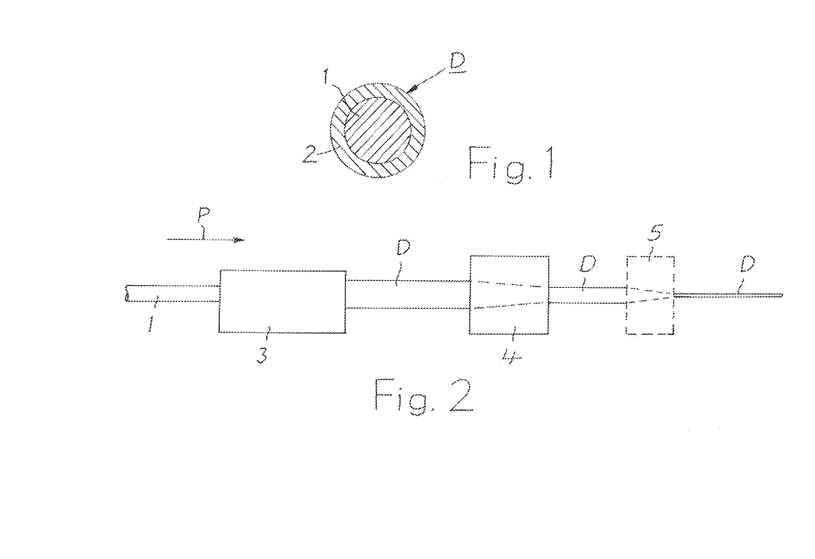

In FIG. 1 a cross section of an electrically conductive wire D is illustrated which has a layer 2 circumferentially surrounding the core. Core 1 and layer 2 are connected to each other through metal. They consist of different materials on the basis of copper.

In a first embodiment of the wire D, the core 1 consists of non-alloyed copper, while the layer 2 consists of a copper alloy. This embodiment of the wire D may be varied by exchanging the two previously mentioned materials. In that case, the core 1 consists of a copper alloy, while the layer 2 consists of non-alloyed copper.

As alloying materials for the copper alloy, advantageously silver or tin or magnesium can be utilized. These alloying materials, as compared to the use of only non-alloyed copper, effect improved mechanical properties of the wire D, particularly with respect to the tensile strength of the wire, its breaking load, and/or its alternating bending strength.

In a second embodiment of the wire D, the core 1 and the layer 2 consist of different copper alloys for which the alloying materials mentioned above can be used, and the embodiment of the wire D can optionally be placed in the core 1 or the layer 2. For example, the core 1 may consist of a copper/tin alloy and the layer 2 may consist of a copper/silver alloy, or vice-versa.

In a copper alloy containing silver, in particular the tensile strength of the wire D is increased, while its electrical conductivity is not substantially influenced. A comparatively increased tensile strength of the wire D is obtained, for example, by using tin in the copper alloy, wherein, however, the electrical conductivity is reduced. The addition of magnesium to the copper alloy increases, for example, the alternating bending property of the wire D in an electrical conductivity which corresponds to the copper alloy with tin as the alloying material.

A prefabricated wire shaped core 1 of non-alloyed copper is, for example, pulled off in the direction of the arrow P from a coil not illustrated, for example, and is fed to a bath 3 in which a copper alloy is contained in the molten state. The core 1 is pulled through the bath 3, so that the layer 2 is applied circumferentially on the layer 2. It connects metallically to the core 1. The thickness of the layer 2 is adjusted through the speed by which the core 1 is pulled through the bath 3. That means that the diameter of the layer 2 is increased by the extent that the core 1 is pulled more slowly through the bath 3. This method is used analogously for a core 1 of a copper alloy and a non-alloyed copper in the molten state for producing the layer 2. Analogously, it is applicable also for the second embodiment of the layer 2 with two different copper alloys.

The finished wire D which leaves the bath 3 could, after sufficient cooling of the layer 2, be wound onto a coil. However, it could advantageously be pulled through a roll unit 4 in which the diameter of the wire D is reduced and simultaneously, the metal bonding between the core 1 and the layer 2 is improved.

The wire D can additionally be pulled through a drawing device 5 which is shown in broken lines in FIG. 2, in which the diameter of the wire is substantially reduced.

Such a wire having, for example, a diameter of 0.1 mm can advantageously be processed, for example, into an electrical strand conductor having a larger number of equally dimensioned wires.

Furthermore, the properties of the wire D can be further adjusted by a targeted annealing in order to obtain, for example, a “semi-soft” wire. In this connection, for example, for a wire D with increased strength, the core 1 should remain hard while, for influencing its expansion or flexibility properties, the layer 2 can be soft annealed.

In the following, an example for the construction of the wire D is indicated with dimensions it has after leaving the roll unit 4. In this example, its diameter is 8.0 mm:

The core 1 consisting of: non-alloyed copper or a copper alloy has a diameter of 4.89 mm. Thus, its cross sectional area is 18.81 mm². The proportion of the core 1 of the total cross section of the wire D is thus 37%. The layer 2, which is composed of a copper alloy or of non-alloyed copper, has a thickness of 1.55 mm. It has a cross sectional area of 31.45 mm and its proportion of the total cross section of the wire D is 63%.

1. Electrically conductive wire which is constructed on the basis of copper comprising:
a core; and
a layer circumferentially surrounding the core and metallically connected to the same,
wherein the core has a proportion of the cross section. of the wire which is between 20% and 50%, while the layer has a corresponding proportion of the wire cross section which is between 80% and 50%,
wherein the core on the one hand, and the layer surrounding the core on the other hand, consist of different materials on the basis of copper.

2. Wire according to claim 1, wherein the different materials are non-alloyed copper and/or a copper alloy.

3. Wire according to claim 1, wherein either the core and the layer surrounding the core is made of non-alloyed copper, and the layer surrounding the same consists of a copper alloy or vice-versa.

4. Wire according to claim 1, wherein either the core is made of a first copper alloy and the layer surrounding the core made of a second alloying material, which is different from the first copper alloy.

5. Wire according to claim 2, wherein silver is utilized as the alloying material for the copper alloy.

6. Wire according to claim 2, wherein tin is used as the alloying material for the copper alloy.

7. Wire according to claim 2, wherein magnesium is utilized as the alloying material for the copper alloy.

8. Method of manufacturing a wire according to claim 1, wherein the layer surrounding the core in the finished wire is applied to the prefabricated core in a molten state and is pulled through the bath.

9. Method according to claim 8, wherein the wire, after applying the layer surrounding the core, is moved through a roll unit for reducing its diameter.

10. Method according to claim 8, wherein the wire is subjected to an annealing process through which the layer surrounding the core is soft annealed without interacting with the core.

11. Method according to claim 8, wherein the wire is subjected to an annealing process by means of which the core is soft annealed without acting on the layer surrounding the core.

12. Method according to claim 8, wherein the diameter of the wire is further reduced in a drawing device.
